(19) United States
(12) Patent Application Publication
(10) Pub. No.: US 2026/0244413 A1
(43) Pub. Date: Aug. 20, 2026

(54) GENERATING EXECUTABLE DESIGN TOOLS

(71) Applicant: AUTODESK, INC., San Francisco, CA (US)

(72) Inventors: Konara Mudiyanselage Kosala BANDARA, Beckenham (GB); Daniele GRANDI, South Lake Tahoe, CA (US); Clayton Paul HOTSON, Kensington, CA (US); Alexander TESSIER, Toronto (CA)

(21) Appl. No.: 19/284,408

(22) Filed: Jul. 29, 2025

Related U.S. Application Data
(60) Provisional application No. 63/760,988, filed on Feb. 20, 2025.

(51) Int. Cl. G06F 8/35; G06F 8/60

(52) U.S. Cl. CPC G06F 8/35; G06F 8/60

(57) ABSTRACT

A computer-implemented method includes receiving, by an AI system, a request to generate an interactive design API, the request comprising unstructured data indicative of an objective to be achieved by using the interactive design API; generating, by the AI system, structured data based on the unstructured data; generating, by the AI system, the interactive design API based on the structured data; and publishing, by the AI system, the interactive design API. Another computer-implemented method includes receiving, by an AI system, multimodal input associated with an objective to be achieved by using an executable tool; determining, by the AI system, based on evaluating the multimodal input, at least one solver to be included in the executable tool for achieving the objective; generating, by the AI system, the executable tool comprising the at least one solver; and publishing, by the AI system, the executable tool.

### CROSS-REFERENCE TO RELATED APPLICATIONS

The present application claims the benefit of U.S. Provisional Application titled, “TECHNIQUES FOR IMPLEMENTING A SELF-ASSEMBLING COMPUTATIONAL DESIGN WORKFLOW,” filed on February 20, 2025, and having Serial No. 63/760,988. The subject matter of this related application is hereby incorporated herein by reference.

### BACKGROUND

### Field of the Various Embodiments

Embodiments of the present disclosure relate generally to executable design tools, and, more specifically, relate to generating an executable design tool using an artificial intelligence (AI) system.

### Description of the Related Art

Executable software is commonly used to perform defined project tasks within technical workflows. A project task may involve computation, control logic, or data manipulation and may require the execution of software that is either custom-developed or constructed from reusable components. Development of executable software for project tasks can vary based on the complexity of the task, the available programming resources, and the required level of functional control. Resulting software implementations may include source code, compiled binaries, or modularized components and may vary in terms of transparency, maintainability, and customizability.

Conventional implementation strategies include approaches that involve low-level programming, modular development using high-level languages, and the use of pre-packaged software. In some cases, a programmer may generate software directly using a low-level language, such as assembly, to exercise precise control over functionality and resource usage. Alternatively, multiple programmers may construct modular components using high-level languages, which are then integrated into a more complex system. Some project tasks may also be addressed using pre-existing software packages that offer general-purpose capabilities applicable to the task at hand.

One drawback of the foregoing approaches is that the foregoing approaches often require specialized expertise, particularly when low-level programming or detailed configuration is involved. This limits accessibility and scalability for complex project tasks. Additionally, such approaches tend to introduce coordination and maintenance challenges. Integration of multiple components – especially when developed by separate contributors or tools – can lead to inconsistencies, regressions, or fragile dependencies. Furthermore, such approaches frequently lack transparency and adaptability, thereby making it difficult to inspect internal logic or to modify functional behavior in a manner that is tailored to specific implementation needs.

As the foregoing illustrates, what is needed in the art are more effective techniques for developing and managing executable software to perform complex project tasks.

### SUMMARY

One embodiment sets forth a computer-implemented method for generating interactive design application programming interfaces (APIs). The computer-implemented method includes receiving, by an artificial intelligence (AI) system, a request to generate an interactive design application programming interface (API), the request comprising unstructured data indicative of an objective to be achieved by using the interactive design API; generating, by the AI system, structured data based on the unstructured data; generating, by the AI system, the interactive design API based on the structured data; and publishing, by the AI system, the interactive design API.

Another embodiment sets forth a computer-implemented method for generating solvers. The computer-implemented method includes receiving, by an artificial intelligence (AI) system, multimodal input associated with an objective to be achieved by using an executable tool; determining, by the AI system, based on evaluating the multimodal input, at least one solver to be included in the executable tool for achieving the objective; generating, by the AI system, the executable tool comprising the at least one solver; and publishing, by the AI system, the executable tool.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques enable the automated generation of interactive application programming interfaces (APIs) and executable tools based on multimodal input processed by an artificial intelligence (AI) system. The multimodal input – which may include text, images, and printed material – is interpreted using large language models (LLMs) and vision language models (VLMs) to construct programmatic elements referred to as solvers. The solvers can be composed into an executable tool configured to perform a coordinated set of functions, such as workflow generation, configuration optimization, size optimization, topology optimization, and simulation. By supporting the creation and modification of such tools through expressive input rather than manual programming, the disclosed techniques reduce dependency on procedural coding and manual integration steps. The architectural shift provided by the disclosed techniques also improves adaptability, as the solvers can be generated dynamically in response to evolving design requirements and assembled into executable tools that reflect specific functional contexts. In addition, the use of AI-based reasoning allows for the incorporation of domain knowledge and latent information from diverse input sources, thereby increasing the efficiency, consistency, and technical depth with which executable tools are constructed and applied.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an example system for generating an interactive design API based on multimodal input in accordance with various embodiments.

FIG. 2 shows some example functional blocks that can be included in the API development system illustrated in FIG. 1.

FIG. 3 illustrates an executable tool development system that is configured to generate an executable tool based on multimodal input in accordance with various embodiments.

FIG. 4 shows some example functional blocks that can be included in the executable tool development system illustrated in FIG. 3.

FIG. 5A illustrates a first example executable tool that includes multiple solvers in accordance with various embodiments.

FIG. 5B illustrates a second example executable tool that includes multiple solvers in accordance with various embodiments.

FIG. 5C illustrates a third example executable tool that includes multiple solvers in accordance with various embodiments.

FIG. 6 illustrates a method for building a design API in accordance with various embodiments.

FIG. 7 illustrates a method for building an example executable tool in accordance with various embodiments.

FIG. 8 illustrates a functional overview of an executable tool development system in accordance with various embodiments.

FIG. 9 is a detailed illustration of a computing device that can implement the functionalities associated with various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

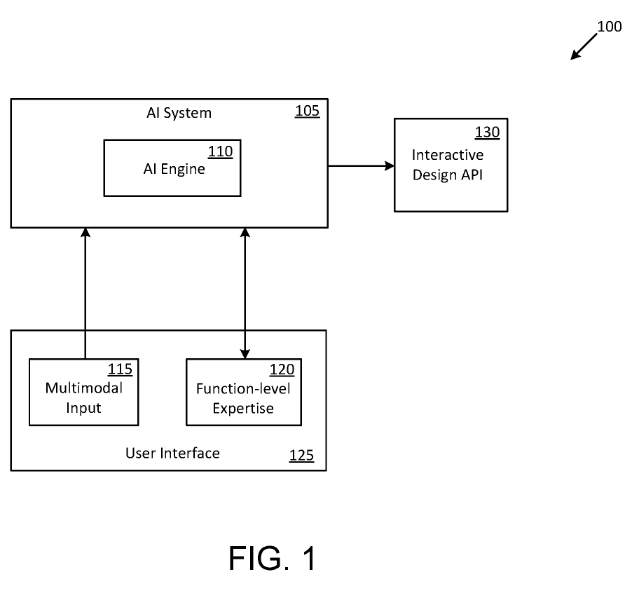

FIG. 1 illustrates an example system 100 for generating an interactive design application programming interface (API) 130 based on multimodal input in accordance with various embodiments. The interactive design API 130, which can be utilized as a customized tool, enables two software entities, referred to as solvers, to cooperate in performing a desired task. For example, one version of the interactive design API 130 can enable a configuration optimization solver to cooperate with a size optimization solver to assist in generating an object. The object can be any of various types, such as a relatively simple cabinet for housing an electronic system, or a complex machine tool that includes various components like gears, linkages, rods, shafts, and cams. In another scenario, one or more versions of the interactive design API 130 can enable a simulation solver to execute a simulation procedure upon an object after generating the object using one or more other solvers.

Generating the interactive design API 130 typically involves enabling the interactive design API 130 to recognize certain types of data provided to the API 130 by a first solver (or by a user), reformatting the data to suit the input requirements of a second solver, providing information such as specifications, conditions, and rules to the second solver, and outputting data to the second solver in conformance with the input requirements of the second solver.

The system 100 enables a developer to generate and configure the interactive design API 130 in a manner that allows a tool user to interact with the interactive design API 130 as part of customizing an object generation tool. Thus, for example, the developer can generate and configure the interactive design API 130 so that the tool user can query the interactive design API 130 for information about a function performed by the interactive design API 130. The tool user can evaluate the information provided by the interactive design API 130 and determine whether to include the interactive design API 130 in a computer-aided design (CAD) tool customized for specific requirements of the user of the tool. The customized CAD tool can be used by the tool user to generate, for example, a CAD drawing of an object that conforms to the tool to the specific needs of the user. In an example scenario, the object can be an improved version of an existing object. In another scenario, the object can be a new concept conceived by the tool user.

In the illustrated example implementation, the system 100 includes a user interface 125 coupled to an AI system 105 that includes an AI engine 110. In some implementations, the AI engine 110 can be an artificial intelligence/machine language (AI/ML) engine. The AI/ML engine can be based on a generative AI model, a regenerative AI model, a deep learning model, and/or a linear regression block. The AI/ML engine typically incorporates various types of algorithms and techniques designed to replicate human intelligence. In some implementations, the AI/ML engine performs machine language operations based on information provided in the form of training data. The training data may be generated based on historic operations performed by the AI/ML engine.

In an example implementation, the user interface 125 enables a tool developer to provide multimodal input 115 and function-level expertise 120. In another example implementation, the user interface 125 operates as an interface between the AI system 105 and another device such as a computer, a modem, a communications transceiver, or another AI system. In this implementation, the other device can provide multimodal input 115.

The multimodal input 115 can be provided in various unstructured forms such as text, images, a hand-drawn sketch, a piece of text, an audio clip, and/or a video clip. In some cases, the multimodal input 115 can be provided to the AI system 105 in a static format, such as an image illustrated in a specification sheet, a book, a magazine, or a photograph. In other cases, the multimodal input 115 can be provided in a dynamic format, such as a video clip, an audio clip, real-time text entry via a keyboard, or an image being sketched by hand on a sketchpad. Hardware used for providing the multimodal input 115 can include items such as a keyboard, a mouse, a joystick, a microphone, a scanner, a camera, a touchpad, a trackpad, a sketchpad, a drawing tablet, and/or a paper tablet.

The unstructured data provided to the AI system 105 as multimodal input 115 is unsuitable for direct processing by the AI engine 110. Consequently, the AI system 105 includes additional components (described below with reference to other figures) that convert the unstructured data to structured data that can be operated upon by the AI engine 110. The AI engine 110 extracts information from the structured data and employs various operations based on AI techniques and expert systems, for example, to generate the interactive design API 130 in response to the information. In an example implementation, the multimodal input 115 includes information about one or more features to be desirably offered by the interactive design API 130. The AI engine 110 evaluates the structured data generated based on the multimodal input 115 and configures the interactive design API 130 to offer the desired features.

Evaluating the information contained in multimodal input 115 is based on various AI techniques such as those relying on function-level expertise 120 provided by the tool developer (via the user interface 125) and/or domain-level expertise obtained from other sources. Such other sources (not shown) can be provided in the form of a retrieval augmented generation (RAG) system or one or more databases in a server or a cloud component communicatively coupled to the AI system 105 via a network such as the Internet.

In an example implementation, function-level expertise 120 is provided by a tool developer with domain knowledge pertaining to APIs and is used by the AI system 105 for generating the interactive design API 130. The user interface 125 can be subsequently used by a tool user for interacting with the interactive design API 130. The tool user can be a person lacking the skills necessary for providing the function-level expertise 120.

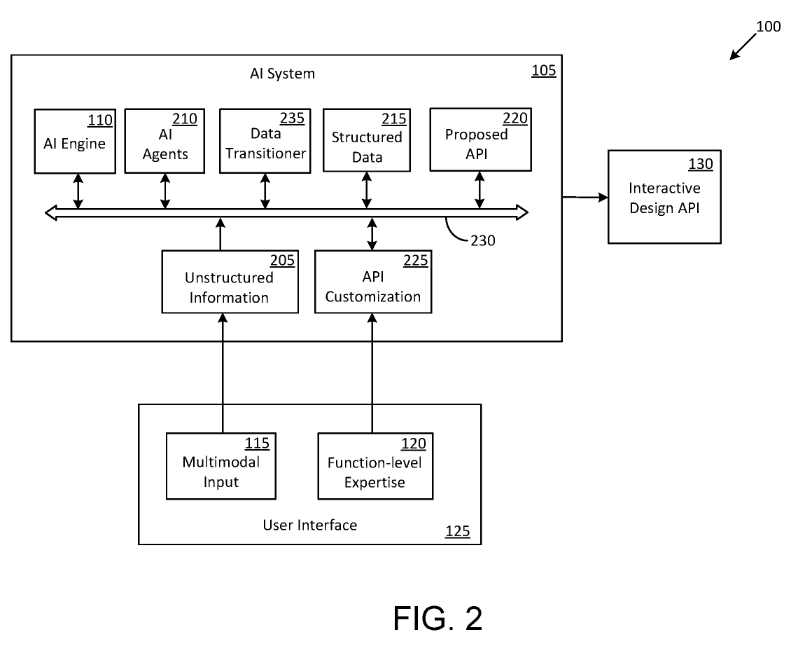

FIG. 2 shows some example functional blocks that can be included in the system 100 described above. In the illustrated example implementation, the AI system 105 includes the AI engine 110 and other components used to implement the various operations associated with generating the interactive design API 130. The multimodal input 115 is received by the AI system 105 as unstructured data 205 (text, images, a hand-drawn sketch, a piece of text, an audio clip, a video clip, etc.). The unstructured data 205 is unsuitable for direct processing by the AI engine 110. A data transitioner 235 is configured to generate structured data 215 based on the unstructured data 205. In an example implementation, the data transitioner 235 is provided in the form of a fluid state data model composed of semi-structured data that acts as a transition between the unstructured data 205 and the structured data 215.

In an example embodiment, the data transitioner 235 is configured to operate upon the unstructured data 205 via interactions with the user interface 105 using LLMs and/or VLMs. More specifically, an LLM can be used for purposes such as text generation, text translation, summarization, code generation, and sentiment analysis. The LLM can, for example, perform text interactions with a user of the user interface 125 and generate code based on the text interaction. The code, which in this case is indicated by the structured data 215, can be generated by the LLM in various programming languages (Python, Java, C++, etc.). Consequently, the unstructured data 205 associated with the multimodal input 115 is automatically converted to code without user involvement in code generation. A user of the user interface 125 can therefore be a person who is unskilled in software coding, software procedures, and/or software techniques.

In an example implementation, the data transitioner 235 operates using assistance provided by AI agents 210. The AI agents 210 autonomously perform tasks on behalf of the data transitioner 235 based on artificial intelligence. The tasks can include processing the unstructured data 205, perceiving sentiment and/or environment in the unstructured data 205, making decisions based on the unstructured data 205, and performing tasks associated with generating the interactive design API 130.

The AI agents 210 can also assist the AI engine 110 in customizing the interactive design API 130 based on the function-level expertise 120. This action is illustrated as API customization 225. The function-level expertise 120 can typically be provided by a person who may or may not be proficient in software coding but is knowledgeable about how APIs operate. More significantly, in this context, the person providing the function-level expertise 120 is knowledgeable about shortcomings in conventional APIs that are preconfigured to provide a fixed set of functionalities, and how such shortcomings can be addressed by generating an API that supports interactions with a user to enable customization to suit specific needs. Accordingly, the person providing the function-level expertise 120 assists the AI engine 110 in generating the interactive design API 130.

Generating the interactive design API 130 can include configuring the interactive design API 130 to interact with a user of the interactive design API 130 in a human-like fashion based on artificial intelligence. Thus, in contrast to a conventional API which can interact with a user in a pre-set, pre-defined manner, the interactive design API 130 is configured to operate based on evaluating and interpreting each unique multimodal input 115 provided by various users.

In an example implementation, the AI engine 110 generates a proposed API 220 based on various types of multimodal input 115 provided to the AI system 105 by a developer. The developer can evaluate the proposed API 220 and modify the multimodal input 115 as desired for customizing the proposed API 220. When satisfied with the customization, the proposed API 220 can be published in the form of the interactive design API 130. Customizing the proposed API 220 can be directed at configuring the interactive design API 130 to support functionalities not typically supported by traditional APIs.

A first example of such functionalities enables the interactive design API 130 to respond to a user query seeking information on a design capability of the interactive design API 130. The response can identify, for instance, that the interactive design API 130 can be used to configure a solver to perform a simulation procedure on certain types of CAD objects. Another example functionality enables the interactive design API 130 to provide instructions related to a setup procedure for using the interactive design API 130. In an example implementation, the interactive design API 130 supports an AI-based interactive dialog enabling a user to perform the setup procedure. The AI-based interactive dialog can involve the AI engine 110 perceiving sentiment and/or environment in the unstructured data 205 for understanding an intent of the user. The user may be given step-by-step instructions and guidance to set up the interactive design API 130.

In an example scenario, the AI engine 110 determines that configuring the interactive design API 130 requires additional details about a component included in a document provided by a user as part of the multimodal input 115. The component can be, for example, an electric motor. The AI engine 110 prompts the user (via a display that can be part of the user interface 125) to provide input about a desired motor torque. Based on the response of the user that indicates the motor torque, the AI engine 110 identifies a commercially available motor that meets the torque requirement of the user. In an example implementation, the identification action is carried out by AI agents 210 (LLM and/or VLM agents with domain knowledge) using a retrieval-augmented generation system (RAG). The RAG enhances pre-existing knowledge provided by the LLMs by accessing and incorporating generative capabilities with information from external data sources, such as a server or a cloud computer. Information, such as the information associated with the commercially available motor, constitutes semi-structured data available to the data transitioner 235 for generating the structured data 215.

The AI system 105 can be used for generating multiple types of interactive design APIs such as the interactive design API 130 described above. The multiple interactive design APIs can be likened to nodes in a graph and interconnections between the nodes can be likened to edges. The graph can represent a design workflow graph that can be tested, debugged, and executed.

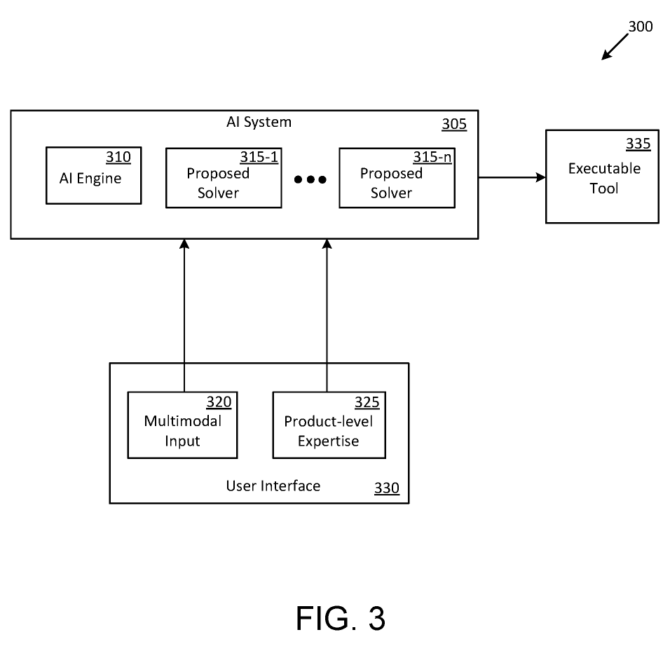

FIG. 3 illustrates a system 300 configured to generate an executable tool 335 based on multimodal input 320 in accordance with various embodiments. In one embodiment, the system 300 includes an AI engine 310 that is substantially similar to the AI engine 110 described above. The user interface 330 enables a tool developer to provide multimodal input 320 and product-level expertise 330. The multimodal input 320 can be provided in various unstructured forms, as described above with reference to multimodal input 115.

Product-level expertise 325 is typically provided by a tool developer having domain knowledge pertaining to executable tools, and is used by the AI system 305 for generating the executable tool 335. The tool developer may or may not be proficient in software coding but is knowledgeable about how executable tools operate. More significantly, in this context, the person providing the product-level expertise 325 is knowledgeable about shortcomings in conventional executable tools preconfigured to provide a fixed set of functionalities, and how these shortcomings can be addressed by generating an executable tool that supports interactions with a user for enabling user customization according to specific needs.

Accordingly, a tool developer provides the product-level expertise 325 to assist the AI engine 310 in generating the executable tool 335. In an example implementation, the tool developer provides input as unstructured data, such as a sketch of a desired workflow diagram. In another example implementation, the tool developer provides input as structured data, such as high-level code or a flow diagram. The user interface 330 can be subsequently used by a tool user for interacting with the executable tool 335. The tool user can be a person lacking the skills necessary for providing the product-level expertise 325 used in generating the executable tool 335.

The AI system 305 includes additional components, such as a data transitioner 450, for converting unstructured data to structured data that can be operated upon by the AI engine 310. More specifically, the AI engine 310 gleans information from the structured data and employs various AI techniques to generate the executable tool 335 in response to the information. In an example implementation, the multimodal input 320 includes information about one or more features to be desirably offered by the executable tool 335. The AI engine 310 evaluates the structured data generated based on the multimodal input 320 and configures the executable tool 335 to offer the desired features.

Evaluating the information contained in multimodal input 320 is based on various AI techniques such as those relying on product-level expertise 325 provided to the system 100 by the tool developer (via the user interface 330) and/or domain expertise obtained from other sources. Such other sources (not shown) can be, for example, a server or a cloud component communicatively coupled to the AI system 305 via a network such as the Internet.

In an example implementation, the executable tool 335 is represented by a workflow structure that includes “n” solvers (n ≥ 1) configured to perform various functions. For example, a first solver (proposed solver 315-1) can be configured to perform configuration optimization, a second solver (proposed solver 315-2) to perform size optimization, a third solver (proposed solver 315-3) to perform parametric optimization, a fourth solver (proposed solver 315-4) to recommend components for product design, a fifth solver (proposed solver 315-5) to perform multi-part topology optimization, and so on.

A first set of such solvers may be suitable for inclusion in one version of the executable tool 335, such as five of the example solvers. A second set of such solvers may be suitable for inclusion in another version of the executable tool 335, such as the third, fourth, and fifth solvers. A third set of such solvers may be suitable for inclusion in yet another version of the executable tool 335, such as the second, fourth, and fifth solvers. A fourth set may be suitable for inclusion in yet another version, such as the first, second, and third solvers.

As described below in more detail, a tool developer configures the AI system 305 to generate the “n” proposed solvers that a user can evaluate for purposes of inclusion in the executable tool 335.

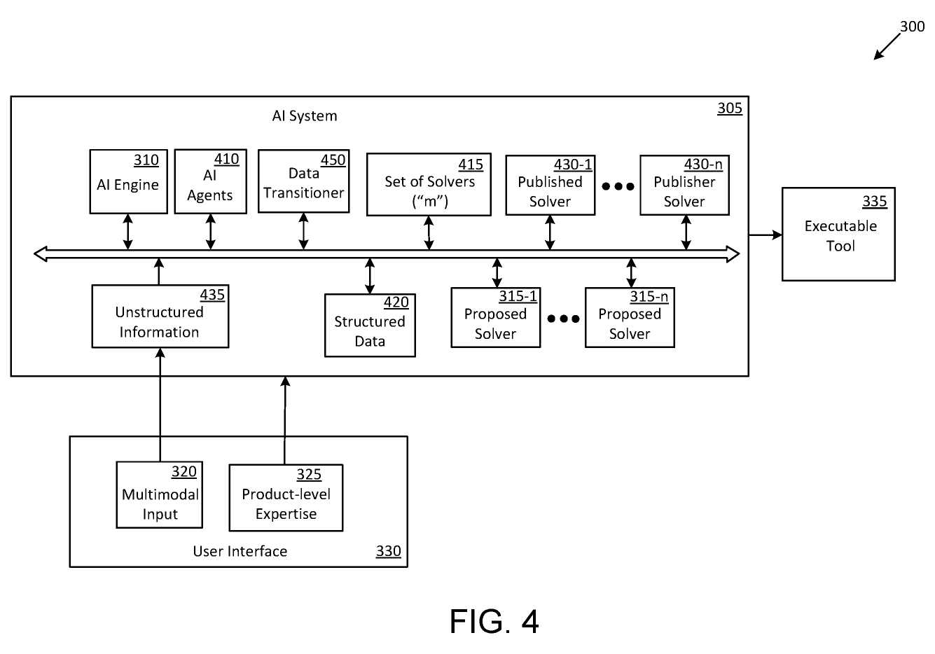

FIG. 4 shows some example functional blocks that can be included in the system 300 described above. In the illustrated example implementation, the AI system 305 includes the AI engine 310 and other components for implementing various operations associated with generating the executable tool 335. The other components include AI agents 410, a set of solvers 415, data transitioner 450, structured data 420, and unstructured data 435. Each of these components can be understood in view of the description provided above regarding AI agents 210, data transitioner 235, structured data 215, and unstructured data 205 respectively shown in FIG. 2. In an example embodiment, the set of solvers 415 can be provided inside the AI system 305. In another embodiment, some or all the solvers of the set of solvers 415 are located outside the AI system 305, such as in a server or a cloud component communicatively coupled to the AI system 305 via a network like the Internet.

In an example operation, a developer configures the AI engine 310 for generating the “n” proposed solvers (315-1 through 315-n) based on the structured data 420. More specifically, the AI engine 310 is configured to select “n” of “m” (m ≥ n) solvers from the set of solvers 415, based on the structured data 420 and assistance provided by product-level expertise 325 and/or AI agents 410. In an example implementation, the set of solvers 415 is generated or provided by experts possessing domain-level knowledge that the tool developer lacks. In another example implementation, some of the set of solvers 415 may be modified by a tool developer with limited domain expertise. In yet another implementation, the tool developer generates some or all of the set of solvers 415.

In an example scenario, the developer configures the AI system 305 to respond to a first request from a user for an executable tool that can achieve an objective, such as generating a graphic rendering of a prototype product and performing various operations upon the rendered prototype product (e.g., simulation, shape optimization, etc.). The first request can include multimodal input 320 in various formats (text, drawings, images, etc.). The AI engine 310 applies AI to evaluate the multimodal input 320 to determine which solvers from the set of solvers 415 would be suitable for inclusion in the requested executable tool.

In an example scenario, the AI engine 110 determines that the multimodal input 115 lacks needed information for enabling the AI system 305 to propose an executable tool in response to the first request. The determination can be made by the AI engine 310 interacting with AI agents 210 (LLM and/or VLM agents with domain knowledge) and/or one or more RAGs. In an example case, the missing information can pertain to two or more moving parts, such as a pair of gears. The AI engine 110 initiates an AI-based dialog with the user to obtain the missing information. The AI-based dialog can resemble human dialog.

The dialog begins with a prompt for the user to provide information about a desired gearing ratio. The user responds with information about the gearing ratio and includes a data sheet with information about various gears. The AI engine 310 evaluates the data sheet and proposes two gears included in the data sheet. The user evaluates the two proposed gears and indicates a preference for a different pair of gears. The AI engine 310 evaluates the information associated with the preferred pair of gears and informs the user that the preferred pair of gears provides a gearing ratio 10% greater than desired. The user may respond by indicating acceptance of the greater gearing ratio.

Based on this user acceptance, the AI engine 310 determines which solvers from the set of solvers 415 would be suitable for the requested executable tool and proposes a first set of proposed solvers for inclusion in the executable tool (“proposed solvers 315-1 through 315-4,” for example). If the first set of proposed solvers satisfies the user, the AI system 305 publishes the set of proposed solvers (“published solvers 430-1 through 430-n”) and includes the published solvers in the executable tool 335.

In an example scenario, the user finds the set of proposed solvers unsatisfactory, such as if a proposed solver performs an operation deemed unnecessary by the user. In this case, the user submits a second request that is exactly identical to the first request. The AI engine 310 evaluates the second request and recognizes it as a duplicate of the first request. Based on this, the AI engine 310 concludes dissatisfaction with the first set of proposed solvers and initiates another AI-based dialog. Based on this second dialog, the AI engine proposes a different set of solvers (“proposed solvers 445-1, proposed solver 445-4, and proposed solver 445-6,” for example).

The operations described with reference to the first and second requests can be repeated until a satisfactory set of proposed solvers is determined. In an example implementation, a second request or subsequent request can differ from the first request, such as based on information gleaned from the first interaction between the user and the AI engine 110 (information regarding the gearing ratio, for example).

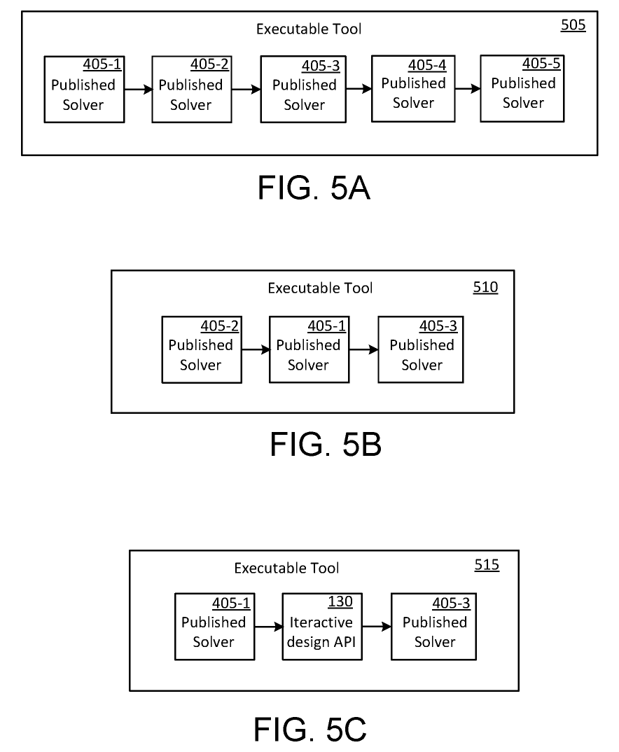

FIG. 5A illustrates an executable tool 505 that can be a first version of the executable tool 335 described above. In this example, the executable tool 505 includes five solvers in a cascaded workflow arrangement. Operations associated with the five solvers are carried out sequentially. In an example scenario, upon execution of the executable tool 505, the functionality associated with published solver 405-5, such as object wireframe rendering or generating a knowledge graph, is performed first. The functionality associated with published solver 405-4, such as adding surface texture to the object wireframe, is performed next. The functionality associated with published solver 405-3, such as creating a prototype of the object, is performed next. The functionality associated with published solver 405-2, such a simulation procedure, is performed next. Finally, the functionality associated with published solver 405-1, such as a product rendering of the object for manufacture, is performed.

FIG. 5B illustrates an executable tool 510 that can be a second version of the executable tool 335 described above. Executable tool 510 includes three of the five solvers described above, arranged in another cascaded workflow. In this case, upon execution, the functionality associated with published solver 405-3 (creating a prototype of the object) is performed first, followed by the functionality associated with published solver 405-1 (product rendering of the object) and the functionality associated with published solver 405-2 (simulation procedure).

FIG. 5C illustrates an executable tool 515 that can be a third version of the executable tool 335 described above. In this case, published solver 405-3 operates cooperatively with published solver 405-1 via an interactive design API 130-1 (described above with reference to FIGS. 1 and 2 ). Interactive design API 130-1 can similarly be used in other arrangements, including those described above with reference to FIGS. 5A and 5B for cooperative operations between multiple solvers.

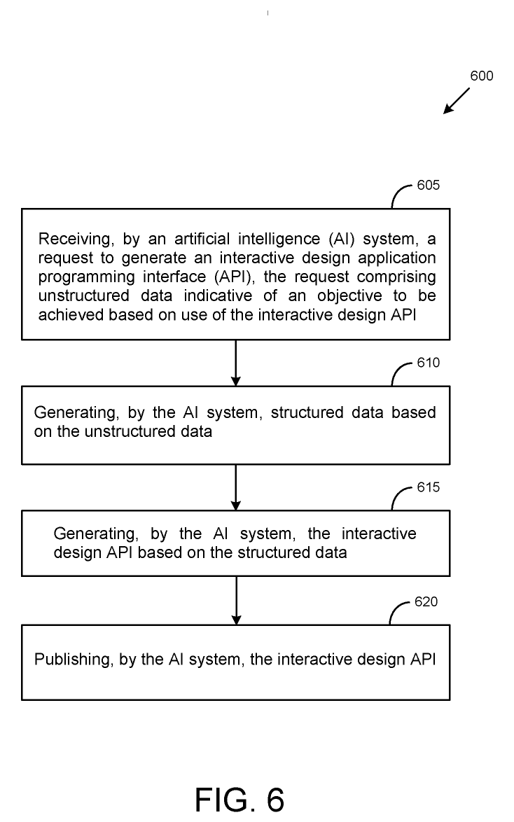

FIG. 6 illustrates an example method 600 for generating executable tools according to various embodiments. At step 605, an artificial intelligence (AI) system receives a request to generate an interactive design API. The request includes unstructured data indicative of an objective to be achieved by using the interactive design API. As described above, the request is received by the AI system 105 as multimodal input 115 via a user interface 125. The multimodal input 115 includes a request to generate an interactive design API for use as part of an executable tool for designing an object.

At step 610, the AI system generates structured data based on the unstructured data. This aspect is described above with respect to FIG. 2, which shows functional blocks representing unstructured data 205 and structured data 215. A data transitioner 235 is configured to generate structured data 215 based on the unstructured data 205. In an example implementation, the data transitioner 235 is provided as a fluid state data model composed of semi-structured data acting as a transition between the unstructured data 205 and structured data 215. In an example embodiment, the data transitioner 235 operates on the unstructured data 205 via interactions with the user interface 105 using LLMs and/or VLMs.

At step 615, the AI system generates the interactive design API based on the structured data. In an example implementation, the AI engine 110 of the API system 105 generates a proposed API 220 based on the types of multimodal input 115 provided to the AI system 105 by a developer. The developer can evaluate the proposed API 220 and modify the multimodal input 115 as desired, for customizing the proposed API 220. When satisfied with the customization, the proposed API 220 can be published in the form of the interactive design API 130. Customizing the proposed API 220 can be directed at configuring the interactive design API 130 to support functionalities typically not supported by traditional APIs.

At step 620, the AI system publishes the interactive design API. In an example implementation, publishing the interactive design API includes publishing a workflow graph. Publishing the interactive design API allows a designer to access and use it for various purposes, such as creating an executable tool according to various embodiments.

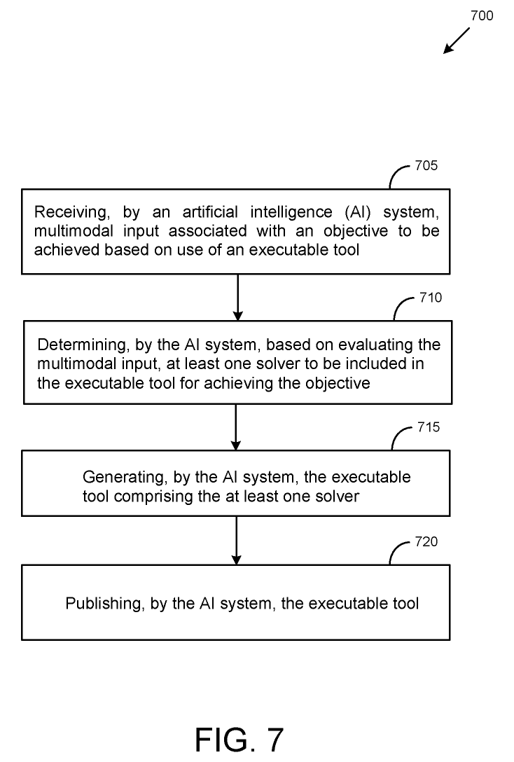

FIG. 7 illustrates an example method 700 for generating executable tools according to various embodiments. At step 705, an AI system receives multimodal input associated with an objective to be achieved by using an executable tool. The multimodal input includes unstructured data indicating the objective to be achieved by using the executable tool. As described above with respect to FIG. 3 and FIG. 4, the AI system 305 receives multimodal input 320 via a user interface 330. The multimodal input 320 can include data such as text, images, a hand-drawn sketch, a piece of text, an audio clip, and a video clip.

At step 710, the AI system determines at least one solver to be included in the executable tool for achieving the objective. The determination is based on evaluating the multimodal input. In an example operation, the AI engine 310 selects “n” out of “m” solvers (m ≥ n) from the set of solvers 415 based on structured data 420, as well as assistance provided via product-level expertise 325 and/or AI agents 410.

At step 715, the AI system generates the executable tool, which includes one or more of the solvers selected at step 710. In an example implementation, a developer generates the executable tool after configuring it to be customizable by a designer. Configuring the executable tool can include enabling the designer to select or modify a proposed executable tool containing one or more solvers. Various designers can customize the executable tool to various projects.

At step 720, the AI system publishes the executable tool. Publishing the executable tool (by a developer, for example) allows a designer to access and use it for various purposes, such as creating an object.

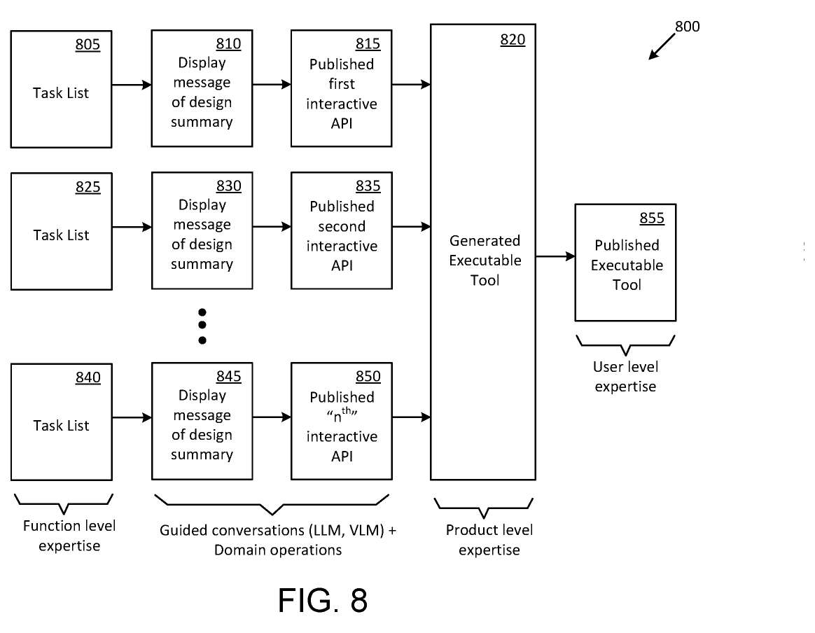

FIG. 8 illustrates a functional overview of an example executable tool development system 800 in accordance with various embodiments. In an example scenario, “n” (n ≥ 1) interactive design APIs are generated based on function level expertise 120. Each of the “n” interactive design APIs can be generated based on a task list provided by a tool developer with domain knowledge pertaining to APIs. The tool developer may or may not be proficient in software coding but is generally knowledgeable about how APIs operate. The task list can be provided in a natural language format to the AI system 105 (e.g., a handwritten list, a printed sheet, an audio clip, etc.). The AI system 105 evaluates the task list and determines a set of operations to be performed for fulfilling the task list. In an example implementation, the task list can be directed at a size optimization functionality. In this case, the AI system 105 identifies a first interactive design API that can be utilized to perform the size optimization functionality (e.g., interactive design API 815). The set of operations can include, for example, a first operation directed to collecting objectives, constraints, and variables, a second operation directed to adding geometry to an object, a third operation directed to checking for boundary conditions, a fourth operation directed to finding target stress, a fifth operation directed to size optimization, and a sixth operation directed to showing results.

The AI system 105 then starts an interactive dialog with the tool developer to obtain information that may be needed to customize the first interactive design API 815 for executing the set of operations. The interactive dialog can be a natural language interaction where the AI system not only asks questions but also proposes various options. For example, the AI system 105 may first interact with the tool developer with respect to the first operation for collecting objectives, constraints, and variables. Based on the interaction, the AI system 105 displays a summary of results. Upon receiving approval from the tool user, the AI system 105 evaluates the second operation pertaining to adding geometry. Based on the evaluation, the AI system 105 starts another interactive dialog with the tool developer to obtain information about a geometry desired by the tool user. Actions associated with such an interaction can include the AI system 105 checking a first table that lists various variables obtained by a first AI agent (e.g., included in AI Agents 210) to determine whether the geometry is included in the variable table. In another scenario, the AI system 105 checks a knowledge graph to obtain information about variables. The knowledge graph stores data in nodes that are interconnected with one another in the form of edges. The first AI agent performs such actions autonomously based on artificial intelligence, which can include analyzing the geometry and determining whether more information is needed. The AI system 105 displays a message requesting the information, followed by loading the geometry into the first variable table, and displaying information pertaining to the geometry loaded into the first variable table.

The AI system 105 then starts an interactive dialog with the tool developer with respect to the third operation pertaining to boundary conditions. Actions associated with such an interaction can include the AI system 105 checking a second variable table obtained by a second AI agent (included in AI Agents 210) to determine whether one or more boundary conditions are included in the second variable table. The second AI agent performs such actions autonomously based on using artificial intelligence to evaluate the boundary condition associated with the third operation. In such a case, the second AI agent determines that the boundary condition is satisfactory, assigns a label to the boundary condition, and displays the label.

The AI system 105 then starts an interactive dialog with the tool developer to obtain information about the target stress associated with the fourth operation. Actions associated with such an interaction can include the AI system checking a third variable table obtained by a third AI agent (included in AI Agents 210) to determine whether the target stress is included in a third variable table. The AI agent performs such an action autonomously based on artificial intelligence, which can include analyzing the target stress based on perceiving sentiment and/or environment. In an example scenario, the AI agent finds the target stress included in the set of tasks provided by the tool developer to be unsuitable. The AI system 105 then displays information about a recommended target stress using known material data. The tool developer may either accept the recommended target stress or provide an alternative target stress. The AI system 105 evaluates the alternative target stress and upon finding it suitable, loads the alternative target stress into the third variable table, and displays information pertaining to the target stress loaded into the third variable table. The AI system 105 then executes the optimization procedure, which is the fifth operation, followed by displaying of the design summary 810 and publishing the first interactive design API 815.

The process described above with reference to the task list 805 can be repeated “n” times for generating and publishing “n” interactive design APIs. The task list 825 includes a different list of tasks than those listed in the task list 805. Such tasks are directed at generating a second interactive design API 835 based on the AI system executing the tasks, displaying the design summary 810, and publishing the second interactive design API 835. Published second interactive API 835 can be different than the published first interactive API 815. The task list 840, which is the “n” task list, includes a different set of tasks than those included in the task list 805 and the task list 825. Such tasks are directed at generating an “nth” interactive design API 850 based on the AI system executing the tasks, displaying the design summary 845, and publishing the “nth” interactive design API 850.

The “n” published APIs can be used by a tool developer having domain knowledge pertaining to solvers and executable tools for generating a published executable tool such as the executable tool 335 described above. The executable tool 335 can be used by a tool user for generating an object (machine part, CAD drawing, etc.). The tool user can be a person lacking the skills necessary for providing the function level expertise needed for generating the published interactive design APIs and the product-level expertise needed for generating the executable tool 335.

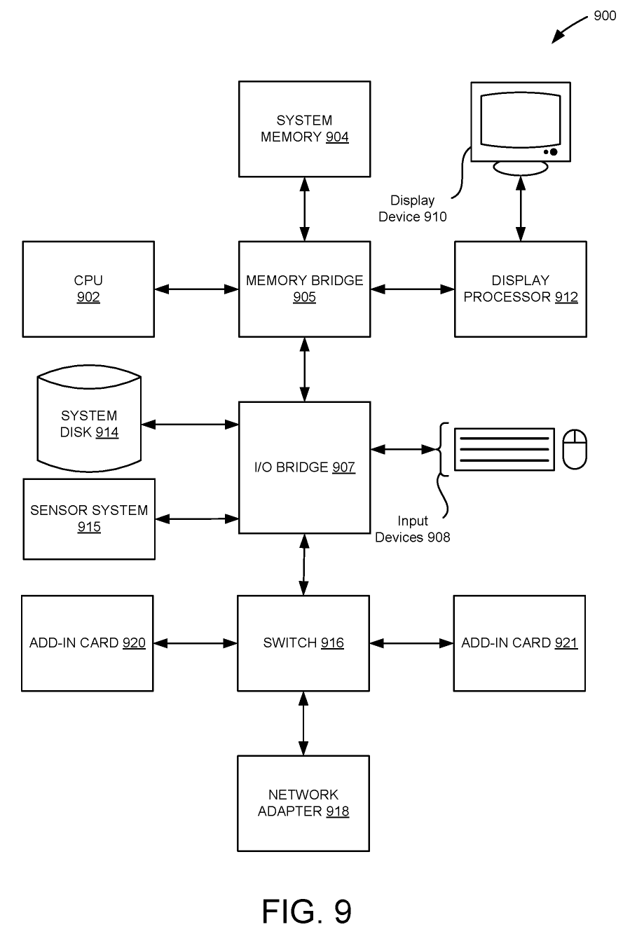

FIG. 9 is a more detailed illustration of a computing device 900 that can implement the functionalities of the systems illustrated in FIGS. 1 through 5 according to various embodiments. This figure in no way limits or is intended to limit the scope of the various embodiments. In various implementations, system 900 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 900 may be coupled together to practice one or more aspects of the various embodiments.

As shown, system 900 includes a central processing unit (CPU) 902 and a system memory 904 communicating via a bus path that may include a memory bridge 905. CPU 902 includes one or more processing cores, and, in operation, CPU 902 is the master processor of system 900, controlling and coordinating operations of other system components. System memory 904 stores software applications and data for use by CPU 902. CPU 902 runs software applications and optionally an operating system. Memory bridge 905, which may be, e.g., a Northbridge chip, is connected via a bus or other communication path (e.g., a HyperTransport link) to an I/O (input/output) bridge 907. I/O bridge 907, which may be, e.g., a Southbridge chip, receives user input from one or more user input devices 908 (e.g., keyboard, mouse, joystick, digitizer tablets, touch pads, touch screens, still or video cameras, motion sensors, and/or microphones) and forwards the input to CPU 902 via memory bridge 905. The user input devices 908 is configured to support multimodal input in various embodiments.

A display processor 912 is coupled to memory bridge 905 via a bus or other communication path (e.g., a PCI Express, Accelerated Graphics Port, or HyperTransport link); in one embodiment display processor 912 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 904.

Display processor 912 periodically delivers pixels to a display device 910 (e.g., a screen or conventional CRT, plasma, OLED, SED or LCD-based monitor or television). Additionally, display processor 912 may output pixels to film recorders adapted to reproduce computer-generated images on photographic film. Display processor 912 can provide display device 910 with an analog or digital signal. In various embodiments, one or more of the various graphical user interfaces are displayed to one or more users via display device 910, and the one or more users can input data into and receive visual output from those various graphical user interfaces.

A system disk 914 is also connected to I/O bridge 907 and may be configured to store content and applications and data for use by CPU 902 and display processor 912. System disk 914 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 916 provides connections between I/O bridge 907 and other components such as a network adapter 918 and various add-in cards 920 and 921. Network adapter 918 allows system 900 to communicate with other systems via an electronic communications network, and may include wired or wireless communication over local area networks and wide area networks such as the Internet.

Other components (not shown), including USB or other port connections, film recording devices, and the like, may also be connected to I/O bridge 907. For example, an audio processor may be used to generate analog or digital audio output from instructions and/or data provided by CPU 902, system memory 904, or system disk 914. Communication paths interconnecting the various components in FIG. 9 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 912 incorporates circuitry optimized for graphics and video processing, including, for example, video output circuitry, and constitutes a graphics processing unit (GPU). In another embodiment, display processor 912 incorporates circuitry optimized for general-purpose processing. In yet another embodiment, display processor 912 may be integrated with one or more other system elements, such as the memory bridge 905, CPU 902, and I/O bridge 907 to form a system on chip (SoC). In still further embodiments, display processor 912 is omitted and software executed by CPU 902 performs the functions of display processor 912.

Pixel data can be provided to display processor 912 directly from CPU 902. In some embodiments, instructions and/or data representing a scene are provided to a render farm or a set of server computers, each similar to system 900, via network adapter 918 or system disk 914. The render farm generates one or more rendered images of the scene using the provided instructions and/or data. These rendered images may be stored on computer-readable media in a digital format and optionally returned to system 900 for display. Similarly, stereo image pairs processed by display processor 912 may be output to other systems for display, stored in system disk 914, or stored on computer-readable media in a digital format.

Alternatively, CPU 902 provides display processor 912 with data and/or instructions defining the desired output images, from which display processor 912 generates the pixel data of one or more output images, including characterizing and/or adjusting the offset between stereo image pairs. The data and/or instructions defining the desired output images can be stored in system memory 904 or graphics memory within display processor 912. In an embodiment, display processor 912 includes 3D rendering capabilities for generating pixel data for output images from instructions and data defining the geometry, lighting shading, texturing, motion, and/or camera parameters for a scene. Display processor 912 can further include one or more programmable execution units capable of executing shader programs, tone mapping programs, and the like.

Further, in other embodiments, CPU 902 or display processor 912 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 902, display processor 912, or one or more other processing devices or any combination of these different processors.

CPU 902, render farm, and/or display processor 912 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 900 may be a robot or robotic device and may include CPU 902 and/or other processing units or devices and system memory 904. In such embodiments, system 900 may or may not include other elements shown in FIG. 9. System memory 904 and/or other memory units or devices in system 900 may include instructions that, when executed, cause the robot or robotic device represented by system 900 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 904 is connected to CPU 902 directly rather than through a bridge, and other devices communicate with system memory 904 via memory bridge 905 and CPU 902. In other alternative topologies display processor 912 is connected to I/O bridge 907 or directly to CPU 902, rather than to memory bridge 905. In still other embodiments, I/O bridge 907 and memory bridge 905 might be integrated into a single chip. The particular components shown herein are optional; for instance, any number of add-in cards or peripheral devices might be supported. In some embodiments, switch 916 is eliminated, and network adapter 918 and add-in cards 920, 921 connect directly to I/O bridge 907.

In sum, the disclosed techniques set forth systems and methods for generating interactive design application programming interfaces (APIs) and executable tools based on a system that enables artificial intelligence (AI) dialog. The AI-based dialog can be initiated by providing multimodal input to the system. The multimodal input, which can be provided in various forms, such as text, images, printed material, audio input, and/or video input, is processed by an AI engine of the system using techniques that include large language models (LLMs) and vision language models (VLMs). Processing the multimodal input involves the AI engine interpreting various types of multimodal input provided by diverse users and generating uniquely customized executable tools. An interactive design API generated based on such an AI-based dialog enables one or more solvers to perform a desired task. For instance, one version of an interactive design API can enable a configuration optimization solver to cooperate with a size optimization solver to assist in generating an object. Another version of an interactive design API can enable a simulation solver to execute a simulation procedure upon an object after generating the object using one or more other solvers.

One technical advantage of the disclosed techniques over the prior art is that the disclosed techniques enable the automated generation of interactive application programming interfaces (APIs) and executable tools based on multimodal input processed by an artificial intelligence (AI) system. The multimodal input – which may include text, images, and printed material – is interpreted using large language models (LLMs) and vision language models (VLMs) to construct programmatic elements referred to as solvers. The solvers can be composed into an executable tool configured to perform a coordinated set of functions, such as workflow generation, configuration optimization, size optimization, topology optimization, and simulation. By supporting the creation and modification of such tools through expressive input rather than manual programming, the disclosed techniques reduce dependency on procedural coding and manual integration steps. The architectural shift provided by the disclosed techniques also improves adaptability, as the solvers can be generated dynamically in response to evolving design requirements and assembled into executable tools that reflect specific functional contexts. In addition, the use of AI-based reasoning allows for the incorporation of domain knowledge and latent information from diverse input sources, thereby increasing the efficiency, consistency, and technical depth with which executable tools are constructed and applied.

1. In some embodiments, a computer-implemented method for generating interactive design application programming interfaces (APIs) comprises receiving a request to generate an interactive design application programming interface (API), the request comprising unstructured data indicative of an objective to be achieved by using the interactive design API; generating, by an artificial intelligence (AI) system, structured data based on the unstructured data; generating, by the AI system, the interactive design API based on the structured data; and publishing, by the AI system, the interactive design API.

2. The computer-implemented method of clause 1, wherein generating the interactive design API includes configuring the interactive design API to support an AI-based dialog.

3. The computer-implemented method of any of clauses 1-2, wherein configuring the interactive design API to support the AI-based dialog comprises enabling the interactive design API to provide information of a design capability of the interactive design API.

4. The computer-implemented method of any of clauses 1-3, wherein enabling the interactive design API to provide information of the design capability comprises enabling the interactive design API to respond to a query seeking information of the design capability.

5. The computer-implemented method of any of clauses 1-4, wherein configuring the interactive design API to support the AI-based dialog further comprises enabling the interactive design API to provide instructions related to a setup procedure for using the interactive design API.

6. The computer-implemented method of any of clauses 1-5, wherein the request is a multimodal input comprising unstructured data, and wherein generating structured data based on the unstructured data comprises interpreting the multimodal input based on at least one of a large language model (LLM) or a vision learning model (VLM).

7. The computer-implemented method of any of clauses 1-6, further comprising: determining, by the AI system, the objective to be achieved based on an AI-based dialog.

8. The computer-implemented method of any of clauses 1-7, wherein determining the objective to be achieved is based on at least one of a large language model (LLM) or a vision language model (VLM).

9. The computer-implemented method of any of clauses 1-8, further comprising: creating a workflow sequence based on the interactive design API.

10. The computer-implemented method of any of clauses 1-9, further comprising: publishing the workflow sequence.

11. In some embodiments, one or more non-transitory computer readable media store instructions that, when executed by one or more processors, cause the one or more processors to perform operations associated with generating interactive design application programming interfaces (APIs), the operations comprising receiving a first request to generate an interactive design application programming interface (API), the first request comprising unstructured data indicative of an objective to be achieved by using the interactive design API; generating, by an artificial intelligence (AI) system, structured data based on the unstructured data; generating, by the AI system, the interactive design API based on the structured data; and publishing, by the AI system, the interactive design API.

12. The one or more non-transitory computer readable media of clause 11, wherein generating, by the AI system, structured data based on the unstructured data comprises transitioning from unstructured data to structured data via a fluid state model composed of semi-structured data.

13. The one or more non-transitory computer readable media of any of clauses 11-12, wherein the operations further comprise: receiving, by the AI system, information associated with a setup procedure for using the interactive design API; and configuring the interactive design API to respond to a second request to use the interactive design API by displaying instructions associated with the setup procedure.

14. The one or more non-transitory computer readable media of any of clauses 11-13, wherein the operations further comprise: receiving, by the AI system, information associated with a design capability of the interactive design API; and configuring the interactive design API to respond to a second request to use the interactive design API by displaying instructions associated with the design capability of the interactive design API.

15. The one or more non-transitory computer readable media of any of clauses 11-14, wherein the first request is a multimodal input comprising unstructured data, and wherein generating structured data based on the unstructured data comprises interpreting the multimodal input based on at least one of a large language model (LLM) or a vision learning model (VLM).

16. The one or more non-transitory computer readable media of any of clauses 11-15, wherein the operations further comprise: determining, by the AI system, the objective to be achieved based on an AI-based dialog .

17. The one or more non-transitory computer readable media of any of clauses 11-16, wherein determining the objective to be achieved is based on at least one of a large language model (LLM) or a vision language model (VLM).

18. The one or more non-transitory computer readable media of any of clauses 11-17, wherein the operations further comprise: creating a workflow sequence based at least in part on the interactive design API.

19. The one or more non-transitory computer readable media of any of clauses 11-18, wherein the operations further comprise: publishing, by the AI system, the workflow sequence.

20. In some embodiments, a computer system comprises one or more memories that include instructions, and one or more processors that are coupled to the one or more memories and that, when executing the instructions, are configured to perform the operations of receiving a request to generate an interactive design application programming interface (API), the request comprising unstructured data indicative of an objective to be achieved by using the interactive design API; generating, by an artificial intelligence (AI) system, structured data based on the unstructured data; generating, by the AI system, the interactive design API based on the structured data, and publishing, by the AI system, the interactive design API.

21. In some embodiments, a computer-implemented method for generating executable tools comprises receiving, by an artificial intelligence (AI) system, multimodal input associated with an objective to be achieved by using an executable tool; determining, by the AI system, based on evaluating the multimodal input, at least one solver to be included in the executable tool for achieving the objective; generating, by the AI system, the executable tool comprising the at least one solver; and publishing, by the AI system, the executable tool.

22. The computer-implemented method of clause 21, wherein determining the at least one solver to be included in the executable tool is further based on an interactive AI-based dialog.

23. The computer-implemented method of any of clauses 21-22, wherein the at least one solver comprises two or more solvers configured to be executed sequentially based on a cascaded arrangement of the two or more solvers.

24. The computer-implemented method of any of clauses 21-23, further comprising: detecting, by the AI system, an ambiguity in the multimodal input; conducting, by the AI system, an interactive AI-based dialog to address the ambiguity; and generating the executable tool based on addressing the ambiguity.

25. The computer-implemented method of any of clauses 21-24, wherein the objective to be achieved is based on generating a graphical rendering of an object, and wherein the ambiguity is associated with a lack of information on one or more components of the object.

26. The computer-implemented method of any of clauses 21-25, wherein the lack of information on the one or more components of the object is determined based on evaluation of the multimodal input by the AI system.

27. The computer-implemented method of any of clauses 21-26, further comprising: proposing, by the AI system, one or more alternative components, based on detecting the lack of information on the one or more components.

28. The computer-implemented method of any of clauses 21-27, wherein the objective to be achieved is based on generating a graphical rendering of an object, and wherein the ambiguity is associated with a lack of information on one or more functional aspects of the object.

29. The computer-implemented method of any of clauses 21-28, further comprising: generating, by the AI system, one or more proposed solvers, based on evaluating the multimodal input; requesting an approval of the one or more proposed solvers; and generating, by the AI system, the executable tool comprising the at least one solver based on the approval.

30. The computer-implemented method of any of clauses 21-29, wherein generating the one or more proposed solvers is based on product-level expertise provided to the AI system by at least one of an AI agent or a tool developer.

31. In some embodiments, one or more non-transitory computer readable media store instructions that, when executed by one or more processors, cause the one or more processors to perform operations associated with generating interactive design application programming interfaces (APIs), the operations comprising receiving, by an artificial intelligence (AI) system, multimodal input associated with an objective to be achieved by using an executable tool; determining, by the AI system, based on evaluating the multimodal input, at least one solver to be included in the executable tool for achieving the objective; generating, by the AI system, the executable tool comprising the at least one solver; and publishing, by the AI system, the executable tool.

32. The one or more non-transitory computer readable media of clause 31, further comprising: conducting, by the AI system, an AI-based dialog that is based on at least one of a large language model (LLM) or a vision language model (VLM); and determining the at least one solver to be included in the executable tool further based on the AI-based dialog.

33. The one or more non-transitory computer readable media of any of clauses 31-32, further comprising: determining the at least one solver to be included in the executable tool further based on domain level expertise provided by at least one of an AI agent or a tool developer.

34. The one or more non-transitory computer readable media of any of clauses 31-33, further comprising: generating, by the AI system, structured data based on unstructured data contained in the multimodal input; and determining the at least one solver to be included in the executable tool further based on the structured data.

35. The one or more non-transitory computer readable media of any of clauses 31-34, further comprising: detecting, by the AI system, an ambiguity in the multimodal input; conducting, by the AI system, an interactive AI-based dialog to address the ambiguity; and generating the executable tool based on addressing the ambiguity.

36. The one or more non-transitory computer readable media of any of clauses 31-35, wherein the objective to be achieved is based on generating a graphical rendering of an object, and wherein the ambiguity is associated with a lack of information on one or more components of the object.

37. The one or more non-transitory computer readable media of any of clauses 31-36, further comprising: proposing, by the AI system, one or more alternative components, based on detecting the lack of information on the one or more components.

38. The one or more non-transitory computer readable media of any of clauses 31-37, wherein the objective to be achieved is based on generating a graphical rendering of an object, and wherein the ambiguity is associated with a lack of information on one or more functional aspects of the object.

39. The one or more non-transitory computer readable media of any of clauses 31-38, further comprising: generating, by the AI system, one or more proposed solvers, based on evaluating the multimodal input; requesting an approval of the one or more proposed solvers; and generating, by the AI system, the executable tool comprising the at least one solver based on the approval.

40. In some embodiments, an artificial intelligence (AI) system comprises one or more memories that include instructions, and one or more processors that are coupled to the one or more memories and that, when executing the instructions, are configured to perform operations of receiving multimodal input associated with an objective to be achieved by using an executable tool; determining, based on evaluating the multimodal input, at least one solver to be included in the executable tool for achieving the objective; generating the executable tool comprising the at least one solver; and publishing the executable tool.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating interactive design application programming interfaces (APIs), the computer-implemented method comprising:
receiving a request to generate an interactive design application programming interface (API), the request comprising unstructured data indicative of an objective to be achieved by using the interactive design API;
generating, by an artificial intelligence (AI) system, structured data based on the unstructured data;
generating, by the AI system, the interactive design API based on the structured data; and
publishing, by the AI system, the interactive design API.

2. The computer-implemented method of claim 1, wherein generating the interactive design API includes configuring the interactive design API to support an AI-based dialog.

3. The computer-implemented method of claim 2, wherein configuring the interactive design API to support the AI-based dialog comprises enabling the interactive design API to provide information of a design capability of the interactive design API.

4. The computer-implemented method of claim 3, wherein enabling the interactive design API to provide information of the design capability comprises enabling the interactive design API to respond to a query seeking information of the design capability.

5. The computer-implemented method of claim 3, wherein configuring the interactive design API to support the AI-based dialog further comprises enabling the interactive design API to provide instructions related to a setup procedure for using the interactive design API.

6. The computer-implemented method of claim 1, wherein the request is a multimodal input comprising unstructured data, and wherein generating structured data based on the unstructured data comprises interpreting the multimodal input based on at least one of a large language model (LLM) or a vision learning model (VLM).

7. The computer-implemented method of claim 1, further comprising:
determining, by the AI system, the objective to be achieved based on an AI-based dialog.

8. The computer-implemented method of claim 7, wherein determining the objective to be achieved is based on at least one of a large language model (LLM) or a vision language model (VLM).

9. The computer-implemented method of claim 7, further comprising:
creating a workflow sequence based on the interactive design API.

10. The computer-implemented method of claim 9, further comprising:
publishing the workflow sequence.

11. One or more non-transitory computer readable media storing instructions that, when executed by one or more processors, cause the one or more processors to
perform operations associated with generating interactive design application programming interfaces (APIs), the operations comprising:
receiving a first request to generate an interactive design application programming interface (API), the first request comprising unstructured data indicative of an objective to be achieved by using the interactive design API;
generating, by an artificial intelligence (AI) system, structured data based on the unstructured data;
generating, by the AI system, the interactive design API based on the structured data; and
publishing, by the AI system, the interactive design API.

12. The one or more non-transitory computer readable media of claim 11, wherein generating, by the AI system, structured data based on the unstructured data comprises transitioning from unstructured data to structured data via a fluid state model composed of semi-structured data.

13. The one or more non-transitory computer readable media of claim 11, wherein the operations further comprise:
receiving, by the AI system, information associated with a setup procedure for using the interactive design API; and
configuring the interactive design API to respond to a second request to use the interactive design API by displaying instructions associated with the setup procedure.

14. The one or more non-transitory computer readable media of claim 11, wherein the operations further comprise:
receiving, by the AI system, information associated with a design capability of the interactive design API; and
configuring the interactive design API to respond to a second request to use the interactive design API by displaying instructions associated with the design capability of the interactive design API.

15. The one or more non-transitory computer readable media of claim 11, wherein the first request is a multimodal input comprising unstructured data, and wherein generating structured data based on the unstructured data comprises interpreting the multimodal input based on at least one of a large language model (LLM) or a vision learning model (VLM).

16. The one or more non-transitory computer readable media of claim 11, wherein the operations further comprise:
determining, by the AI system, the objective to be achieved based on an AI-based dialog .

17. The one or more non-transitory computer readable media of claim 16, wherein determining the objective to be achieved is based on at least one of a large language model (LLM) or a vision language model (VLM).

18. The one or more non-transitory computer readable media of claim 16, wherein the operations further comprise:
creating a workflow sequence based at least in part on the interactive design API.

19. The one or more non-transitory computer readable media of claim 18, wherein the operations further comprise:
publishing, by the AI system, the workflow sequence.

20. A computer system, comprising:
one or more memories that include instructions; and
one or more processors that are coupled to the one or more memories and, when executing the instructions, are configured to perform the operations of:
receiving a request to generate an interactive design application programming interface (API), the request comprising unstructured data indicative of an objective to be achieved by using the interactive design API;
generating, by an artificial intelligence (AI) system, structured data based on the unstructured data;
generating, by the AI system, the interactive design API based on the structured data; and
publishing, by the AI system, the interactive design API.
